(19) United States
(12) Patent Application Publication
(10) Pub. No.: US 2009/0046026 A1
(43) Pub. Date: Feb. 19, 2009

(54) CIRCULARLY POLARIZED ANTENNA

(76) Inventors: Hisamatsu Nakano, Tokyo (JP); Akira Miyoshi, Tokyo (JP); Isao Fukae, Tokyo (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/279,045

(22) PCT Filed: Dec. 21, 2006
(86) PCT No.: PCT/JP2006/325474

§ 371 Date: Aug. 11, 2008

(30) Foreign Application Priority Data
Feb. 14, 2006 (JP) 2006-035985

(51) Int. Cl. H01Q 11/12

(52) U.S. Cl. 343/741

(57) ABSTRACT

To provide a circularly polarized antenna capable of obtaining an excellent axial ratio over a very wide range and having a great gain in a zenith direction. The circularly polarized antenna (10) includes a planar loop antenna element (122) and feeding means for providing quadruple feeds with their phases varied by 90 degrees with respect to the planar loop antenna element (122). The feeding means has four feeding probes (131 through 134). The circularly polarized antenna (10) is provided with a circuit board (25) disposed in parallel with the planar loop antenna element (122). The circuit board (25) has an area greater than that of the planar loop antenna element (122). The circuit board (25) has a principal surface (25U) which entirely serves as a ground plane. The circuit board (25) has a rear surface (25L) provided with a 90-degree phase shifter formed thereon.

### TECHNICAL FIELD

This invention relates to a circularly polarized antenna and, in particular, to a circularly polarized antenna used for reading out information related to a commercial product from a microminiature wireless IC chip, called a μ chip, which is embedded into the commercial product as a product tag (IC tag).

### BACKGROUND ART

Heretofore, in order to identify a commercial product (article), a barcode is attached to the commercial product. Then, the barcode is read out by a barcode reader to thereby read out information related to the commercial product.

In recent years, a microminiature wireless IC chip called a μ chip is developed and the μ chip is increasingly becoming preliminarily embedded into a commercial product as a product tag (IC tag). Then, between the μ chip and an antenna, an electric wave is transmitted/received. In this manner, information related to the commercial product can be read out. A frequency of the electric wave used here is 2.4 GHz and the electric wave is a circularly polarized wave.

As a circularly polarized antenna for transmitting/receiving the electric wave (circularly polarized wave) between it and the μ chip, various types of antennas can be used. One of such antennas is a planar antenna using a loop antenna, which is disclosed in, for example, Patent Document 1. In Patent Document 1, a loop element having a perimeter length corresponding to about one wavelength is arranged in parallel with a ground plane with a space left therefrom and a feeding conductor corresponding to about ¼ wavelength is arranged between the loop element and the ground plane in parallel with a loop of the loop element. The feeding conductor has one end which is connected to a central conductor of a coaxial line, and the ground plane is connected to an external conductor thereof. The loop element is fed from the feeding conductor through electromagnetic coupling.

Further, Patent Document 2 discloses “a loop antenna” intended to achieve miniaturization of the loop antenna and reduction in the number of components and in assembling man-hour. In Patent Document 2, a double-sided printed circuit board has an upper surface entirely serving as a ground plane and a rear surface on which an RF circuit is formed. A loop element is arranged above the ground plane in parallel therewith. Between the loop element and the ground plane, a feeding conductor is disposed. The feeding conductor is connected to the RF circuit on the rear surface of the printed circuit board to feed from the feeding conductor to the loop element through electromagnetic coupling. Patent Document 2 also discloses an embodiment in which first and second feeding conductors are disposed between the loop element and the ground plane, with their feeding points having an angular interval of 90° therebetween in relation to a center of a loop. The loop element is fed from the feeding conductors through electromagnetic coupling. Thus, it is possible to selectively transmit/receive a left-handed circularly polarized wave and a right-handed circularly polarized wave.

Furthermore, Patent Document 3 discloses a thin planar antenna capable of dealing with a horizontally polarized wave and a vertically polarized wave, or a left-handed circularly polarized wave and a right-handed circularly polarized wave. In the planar antenna disclosed in Patent Document 3, a loop-shaped antenna element is arranged in parallel with a ground plane, and first and second feeding conductors having feeding points shifted by 90° are arranged between a loop element and the ground plane. The first and the second feeding conductors are connected to central conductors of first and second coaxial lines, respectively, and external conductors of the first and the second coaxial lines are connected to the ground plane to feed the antenna element through electromagnetic coupling. In case of feeding from the first feeding conductor, the horizontally polarized wave is radiated. In case of feeding from the second feeding conductor, the vertically polarized wave is radiated. By switching the first and the second feeding conductors, it is possible to transmit/receive the horizontally polarized wave and the vertically polarized wave. Further, if the loop element is provided with a perturbation element, the antenna becomes an antenna for left-handed/right-handed circularly polarized waves.

Furthermore, Patent Document 4 discloses an electromagnetic coupling type N-point feeding loop antenna capable of easily obtaining impedance matching, although it is not an antenna for an IC tag. The electromagnetic coupling type N-point feeding loop antenna disclosed in Patent Document 4 comprises a cylindrical body formed by rounding a flexible insulating film member around a center axis into a cylindrical shape and a loop portion made of a loop-shaped conductor formed around the center axis along a peripheral surface of the cylindrical body. In order to feed the loop portion at N (N being an integer not less than 2) points, the cylindrical body is provided with N feeders formed on the peripheral surface thereof. Between the loop portion and each of the N feeders, a gap is formed. Feeding to the loop portion is provided through electromagnetic coupling. The cylindrical body is erected on a principal surface of a circuit board and fixed thereto, and an N-point feeding phase shifter connected to the N feeders is formed on the principal surface of the circuit board.

Patent Document 1: JP-A-H11-205028

Patent Document 2: JP-A-H11-220317

Patent Document 3: JP-A-H11-266120

Patent Document 4: JP-A-2003-174314

### DISCLOSURE OF THE INVENTION

### Problem to be Solved by the Invention

However, in the loop antenna disclosed in Patent Document 1, the loop element is fed by using one feeding conductor through electromagnetic coupling. Therefore, there is a problem that an excellent axial ratio can not be obtained over a wide band.

Further, Patent Documents 2 and 3 disclose the loop antennas (planar antennas) capable of selectively transmitting/receiving a left-handed circularly polarized wave and a right-handed circularly polarized wave by disposing the first and the second feeding conductors between the loop element and the ground plane, with their feeding points shifted by 90° in relation to the center of the loop. However, in the loop antennas (planar antennas) disclosed in Patent Documents 2 and 3, one of the first and the second feeding conductors is selectively used. Thus, only one feeding conductor is used at a time. As a result, similarly to the loop antenna disclosed in the above-mentioned Patent Document 1, there is a problem that an excellent axial ratio can not be obtained over a wide band.

On the other hand, Patent Document 4 discloses the loop antenna in which the one linear loop portion (loop element) is fed by the N feeders (feeding conductors) through electromagnetic coupling. However, since the loop antenna disclosed in Patent Document 4 has the linear loop portion (loop element), there is a problem that a gain in a zenith direction is low.

It is therefore an object of the present invention to provide a circularly polarized antenna capable of obtaining an excellent axial ratio over a very wide range.

It is another object of the present invention to provide a circularly polarized antenna with a high gain in a zenith direction.

### Means to Solve the Problem

According to a first aspect of the present invention, there is provided a circularly polarized antenna comprising a planar loop antenna element and feeding means for providing N-tuple (N being an integer not less than two) feeds with their phases varied by (360/N) degrees with respect to the planar loop antenna element.

In the above-mentioned circularly polarized antenna according to the present invention, the feeding means comprises first through N-th feeding probes. The circularly polarized antenna comprises a (360/N)-degree phase shifter connected to the first through the N-th feeding probes. The planar loop antenna element may have a planar square loop shape or a planar circular loop shape. Each of the first through the N-th feeding probes has an inverted L shape, an L shape, a T shape, or an inverted triangular shape (13C).

According to a second aspect of the present invention, there is provided a circularly polarized antenna comprising an antenna board having a planar antenna element pattern formed on an upper surface thereof, N feeding probes (N being an integer not less than two) with their phases varied by (360/N) degrees for the purpose of feeding the planar antenna element pattern through electromagnetic coupling, a ground plate disposed in parallel with the antenna board, a circuit board disposed on a rear surface of the ground plate, the circuit board being provided with a (360/N)-degree phase shifter which is formed on a rear surface thereof and which is connected to the N feeding probes, a base having N grooves for mounting the N feeding probes and disposed between the ground plate and the antenna board, and fastening means (11, 16) for fastening the antenna substrate and the ground plate with the base sandwiched therebetween.

### EFFECT OF THE INVENTION

In the present invention, the planar loop antenna element is given N-tuple feeds with their phases varied by (360/N) degrees. Therefore, the present invention exhibits an effect that an excellent axial ratio can be obtained over a very wide range and a gain in a zenith direction can be increased.

### BRIEF DESCRIPTION OF THE DRAWINGS

FIG. 1 is a perspective view of a circularly polarized antenna according to one embodiment of the present invention.

FIG. 2 is a front view of the circularly polarized antenna shown in FIG. 1.

FIG. 3 is a graph showing axial ratio/frequency characteristics of a conventional circularly polarized antenna and the circularly polarized antenna shown in FIG. 1.

FIG. 4 is a perspective view showing another example of a planar loop antenna element used in the circularly polarized antenna of the present invention.

FIG. 5 is a front view showing another example of a feeding probe used in the circularly polarized antenna of the present invention.

FIG. 6 is a front view showing still another example of the feeding probe used in the circularly polarized antenna of the present invention.

FIG. 7 is a front view showing yet another example of the feeding probe used in the circularly polarized antenna of the present invention.

FIG. 8 is a schematic exploded sectional view of a circularly polarized antenna according to one example of the present invention.

FIG. 9 is a plan view of the circularly polarized antenna illustrated in FIG. 8.

FIG. 10 is a bottom view of the circularly polarized antenna illustrated in FIG. 8.

FIG. 11 is a side view of the circularly polarized antenna illustrated in FIG. 8.

FIG. 12 is a plan view of a case used in the circularly polarized antenna illustrated in FIG. 8.

FIG. 13 is a bottom view of the case illustrated in FIG. 12.

FIG. 14 is a side view of the case illustrated in FIG. 12.

FIG. 15 is a sectional view taken along a line XV-XV in FIG. 12.

FIG. 16 is a plan view of an antenna substrate used in the circularly polarized antenna illustrated in FIG. 8.

FIG. 17 is a plan view of a base used in the circularly polarized antenna illustrated in FIG. 8.

FIG. 18 is a bottom view of the base illustrated in FIG. 17.

FIG. 19 is a side view of the base illustrated in FIG. 17.

FIG. 20 is a sectional view taken along a line XX-XX in FIG. 17.

FIG. 21 is a sectional view taken along a line XXI-XXI in FIG. 17.

FIG. 22 is a plan view of a ground plate used in the circularly polarized antenna illustrated in FIG. 8.

FIG. 23 is a bottom view of the ground plate illustrated in FIG. 22 and a circuit board.

FIG. 24 is a side view of the ground plate illustrated in FIG. 22.

FIG. 25 is a sectional view taken along a line XXV-XXV in FIG. 23.

FIG. 26 is a plan view showing a cable used in the circularly polarized antenna illustrated in FIG. 8.

### BEST MODE FOR EMBODYING THE INVENTION

Hereinbelow, an embodiment of the present invention will be described in detail with reference to the drawing.

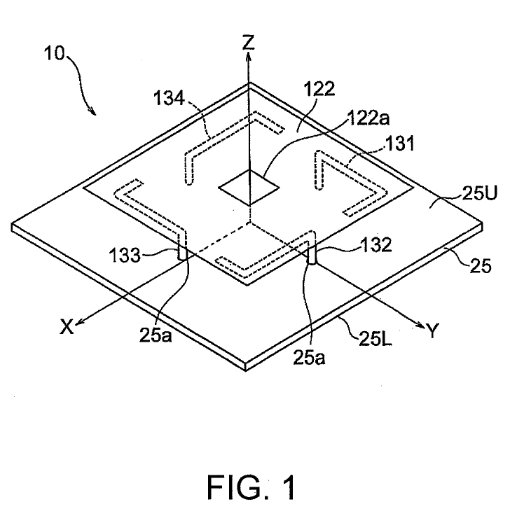

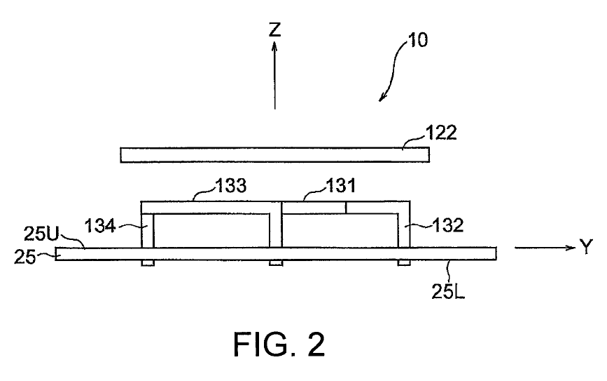

Referring to FIGS. 1 and 2, a circularly polarized antenna 10 according to one embodiment of the present invention will be described. FIG. 1 is a perspective view of the circularly polarized antenna 10 and FIG. 2 is a front view of the circularly polarized antenna 10. The illustrated circularly polarized antenna 10 is an antenna for use in transmitting/receiving an electric wave between it and the above-mentioned IC tag. In FIG. 1, as a coordinate system, a back-and-forth direction, a horizontal direction, and a vertical direction are defined as an X-axis direction, a Y-axis direction, and a Z direction, respectively.

The illustrated circularly polarized antenna 10 comprises a planar loop antenna element 122 and feeding means for providing quadruple feeds with their phases varied by 90 degrees with respect to the planar loop antenna element 122. The illustrated feeding means comprises first through fourth feeding probes 131, 132, 133, and 134. Each of the first through the fourth feeding probes 131 through 134 has an inverted L shape. The illustrated planar loop antenna element 122 has a planar square loop shape and has a uniform width in a radial direction. The planar loop antenna element 122 has a rectangular hole 122a formed in a center region thereof.

The planar loop antenna element 122 has a greater difference between an inner perimeter length and an outer perimeter length than that of a linear loop antenna element made of a wire. The length intermediate between the inner perimeter length and the outer perimeter length corresponds to about one wavelength. Consequently, a resonance bandwidth is expanded.

The circularly polarized antenna 10 further comprises a circuit board 25 arranged in parallel with the planar loop antenna element 122. The circuit board 25 has an area greater than that of the planar loop antenna element 122. The circuit board 25 has an upper surface (principal surface) 25U and a lower surface (rear surface) 25L. The upper surface (principal surface) 25U of the illustrated circuit board 25 entirely serves as a ground plane. The lower surface (rear surface) 25L of the circuit board 25 has a 90-degree phase shifter formed thereon, which will later be described. The circuit board 25 has four penetration holes 25a to allow the feeding probes 131 through 134 to pass therethrough, respectively.

Thus, above the ground plane 25U, the planar loop antenna element 122 is disposed in parallel with the ground plane 25U. Between the planar loop antenna element 122 and the ground plane 25U, the four feeding probes 131 through 134 are disposed. Each of the feeding probes 131 through 134 penetrates through the penetration hole 25a, which is a non through-hole, to the lower surface (rear surface) 25L of the circuit board 25 and is connected to the 90-degree phase shifter (not shown).

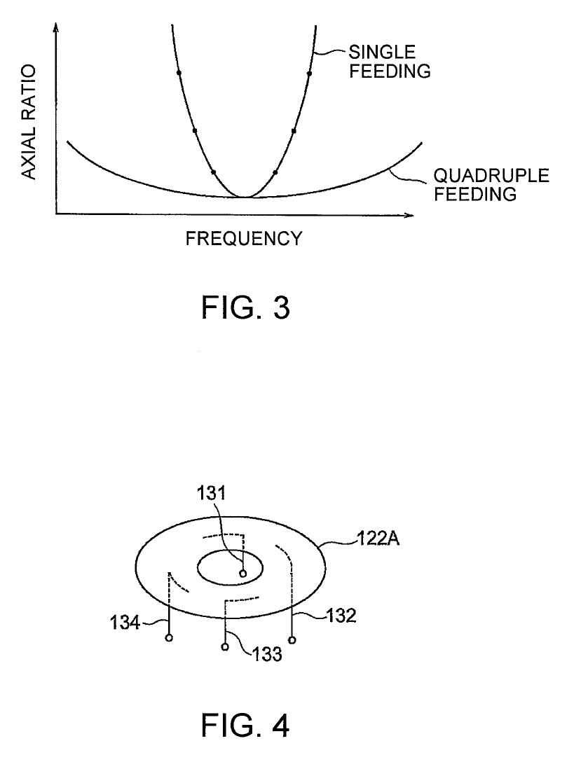

FIG. 3 is a graph showing axial ratio characteristics of a conventional circularly polarized antenna having only one feeding conductor (feeding probe) and the circularly polarized antenna 10 according to the present invention. In FIG. 3, a curve labeled SINGLE FEED shows the axial ratio characteristic of the conventional circularly polarized antenna, while another curve labeled QUADRUPLE FEEDS shows the axial ratio characteristic of the circularly polarized antenna 10 according to the present invention. In FIG. 3, the ordinate represents an axial ratio and the abscissa represents a frequency. From FIG. 3, it is understood that the circularly polarized antenna 10 according to the present invention can obtain an excellent axial ratio over a very wide band in comparison with the conventional circularly polarized antenna.

Further, in comparison with a circularly polarized antenna having a linear loop antenna element as disclosed in Patent Document 4, the circularly polarized antenna 10 according to the present invention has the planar loop antenna element 122 having a greater transmission/reception area. As a result, the circularly polarized antenna 10 according to the present invention has an advantage that a gain in a zenith direction Z is great.

In the circularly polarized antenna 10 illustrated in FIG. 1, the planar loop antenna element 122 has a planar square loop shape and each of the first through the fourth feeding probes 131 through 134 has an inverted L shape. However, it is readily understood that the planar loop antenna element and the feeding probe are not limited to these shapes.

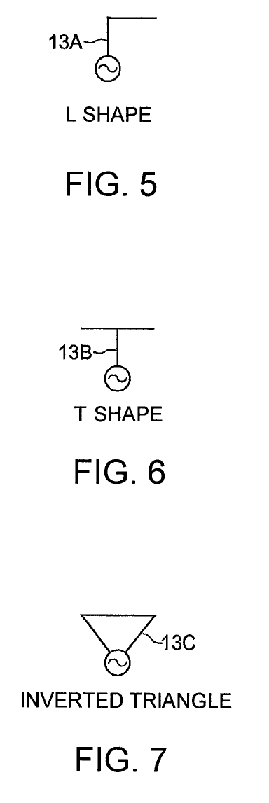

For example, as the planar loop antenna element, use may be made of a planar loop antenna element 122A having a planar circular loop shape as shown in FIG. 4. Further, as the feeding probe, an L-shaped feeding probe 13A as shown in FIG. 5, a T-shaped feeding probe 13B as shown in FIG. 6, or an inverted triangular feeding probe 13C as shown in FIG. 7 may be used.

### EXAMPLES

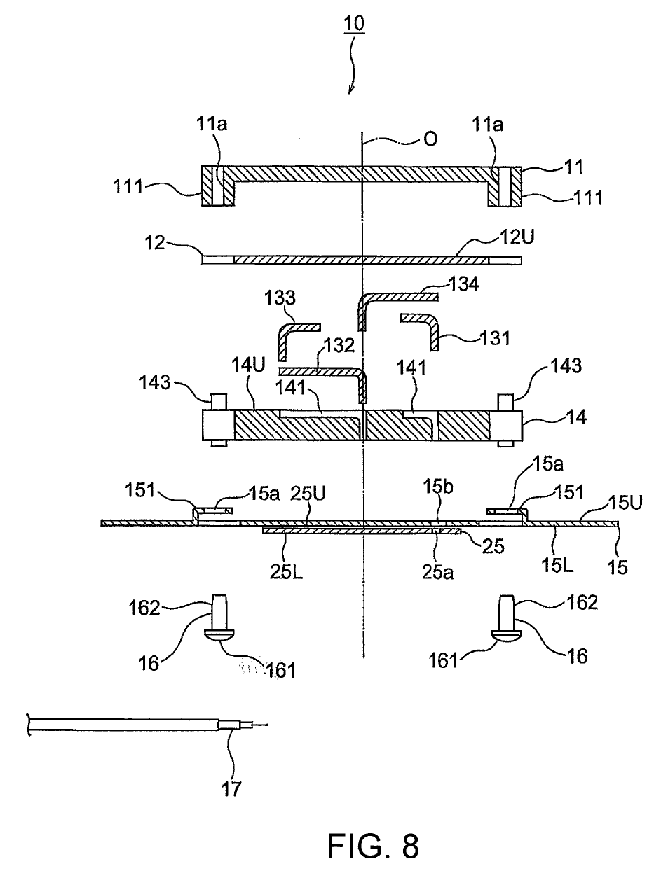

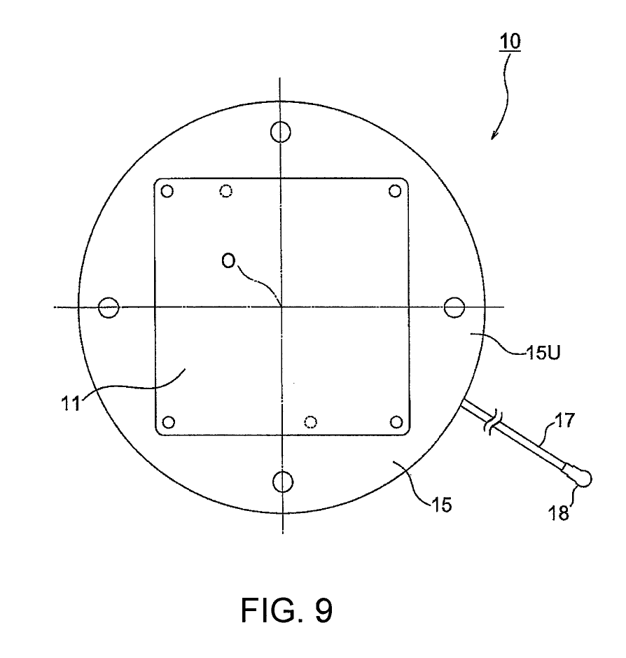

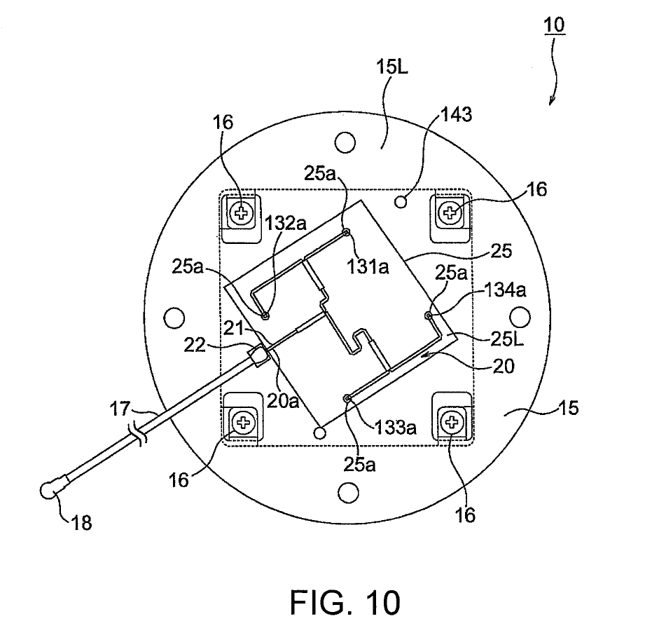

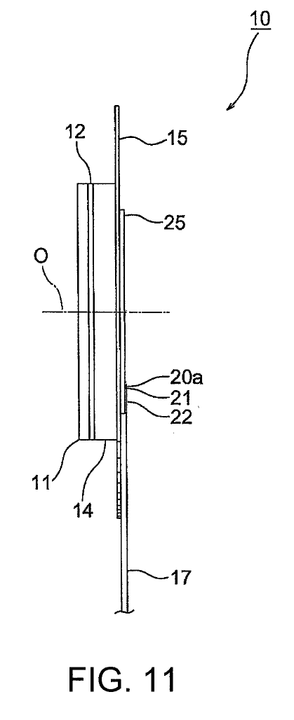

Referring to FIGS. 8 through 11, description will be made about a specific example (example) of the circularly polarized antenna 10 according to the first embodiment of the present invention. FIG. 8 is a schematic exploded sectional view of the planar antenna 10. FIG. 9 is a plan view of the circularly polarized antenna 10. FIG. 10 is a bottom view of the circularly polarized antenna 10. FIG. 11 is a side view of the circularly polarized antenna 10. The illustrated circularly polarized antenna 10 is an antenna for use in transmitting/receiving an electric wave between it and the above-mentioned IC tag.

The illustrated circularly polarized antenna 10 comprises a case 11, an antenna board 12, first through fourth feeding probes (feeding conductors) 131 through 134, a base 14, a ground plate 15, and the circuit board 25. The case 11 is made of, for example, a resin material such as heat resistant ABS resin, and has a shape of a substantially square plate. Each of the first through the fourth feeding probes 131 through 134 is made of a copper wire and has a generally inverted L shape. The base 14 is made of, for example, a resin material such as heat resistant ABS resin, and has a shape of a substantially square plate. The ground plate 15 has a shape of a substantially circular plate. The circuit board 25 has a substantially rectangular shape.

On an upper surface 15U of the ground plate 15, the base 14 is disposed in alignment with a center axis O. The base 14 has four L-shaped grooves 141 for mounting the feeding probes 131 through 134, respectively. The base 14 has an upper surface 14U on which the antenna substrate 12 is disposed. The antenna substrate 12 has a planar antenna element pattern 122 formed thereon as will later be described. On an upper surface 12U of the antenna board 12, the case 11 is mounted. The ground plate 15, the base 14, the antenna board 12, and the case 11 are integrally fixed by tapping screws 16, four in number, as will later be described. The feeding probes 131 through 134 are adapted to feed the planar antenna element pattern 122 through electromagnetic coupling.

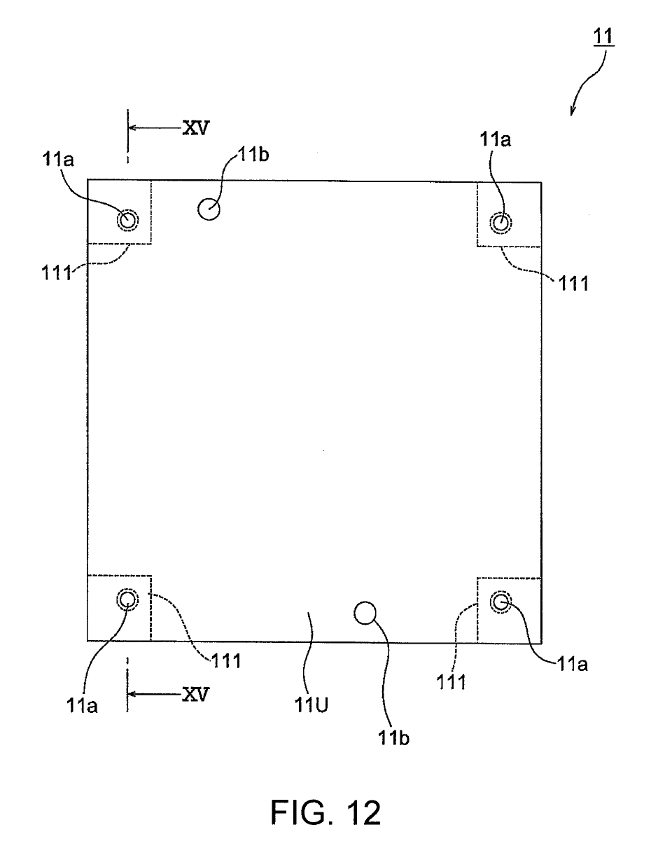

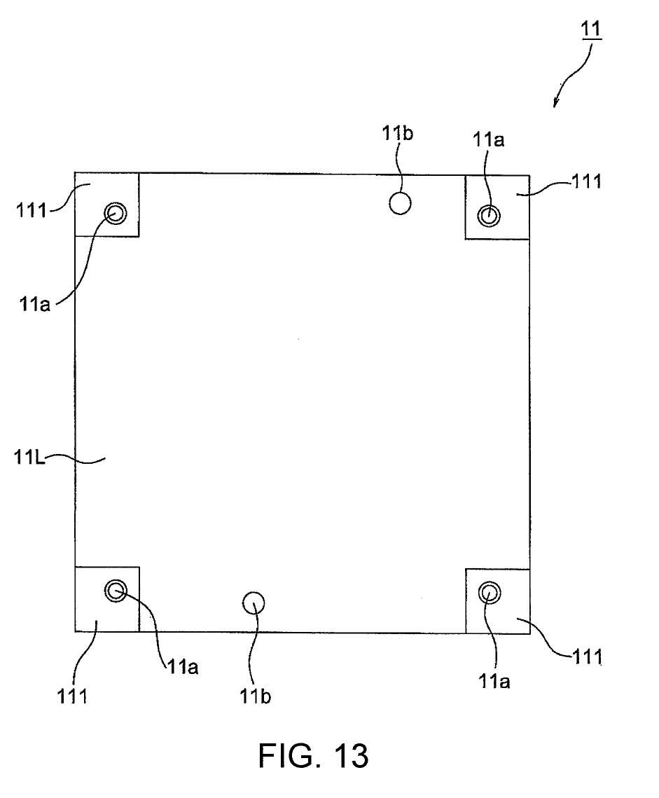

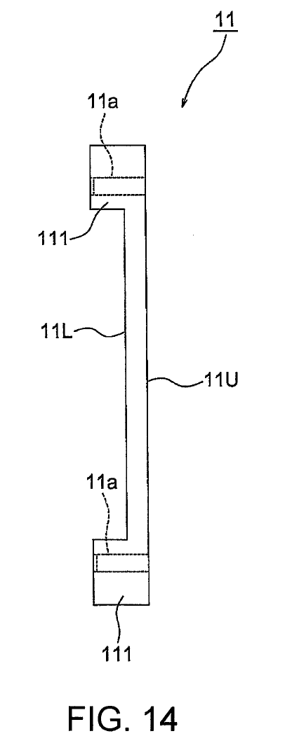

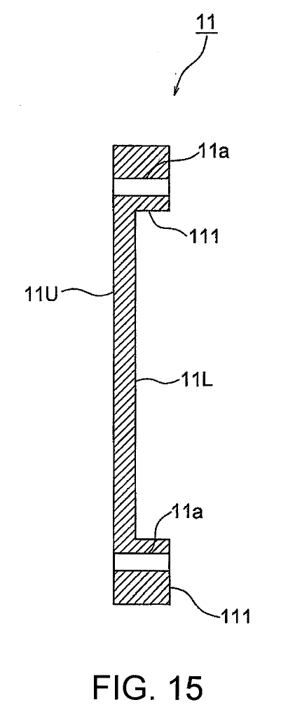

Referring to FIGS. 12 through 15, the description will be made about the case 11. FIG. 12 is a plan view of the case 11. FIG. 13 is a bottom view of the case 11. FIG. 14 is a side view of the case 11. FIG. 15 is a sectional view taken along a line XV-XV in FIG. 12.

The case 11 has an upper surface 11U and a lower surface 11L. The case 11 has four bosses 111 each of which has a rectangular solid shape and which project downwards from the lower surface 11L at four corners. Each of the bosses 111 is provided with a screw hole 11a having an internal thread formed therein for screw engagement with the above-mentioned tapping screw 16. Therefore, each of the bosses 111 functions as a nut to which the tapping screw 16 is screwed. Consequently, a nut as a separate component is not necessary to thereby reduce the number of components. Further, the screw hole 11a has a length greater than that of a threaded part 162 of the tapping screw 16. Consequently, the threaded part 162 of the tapping screw 16 does not project from the upper surface 11U of the case 11. Furthermore, the case 11 has two penetration holes 11b formed therethrough and adapted to insert positioning pins of the base 14, which will later be described.

In any event, in the present embodiment, a combination of the case 11 having the four bosses 111 and the four tapping screws 16 serves as fastening means for fastening the antenna substrate 12 and the ground plate 15 with the base 14 sandwiched therebetween.

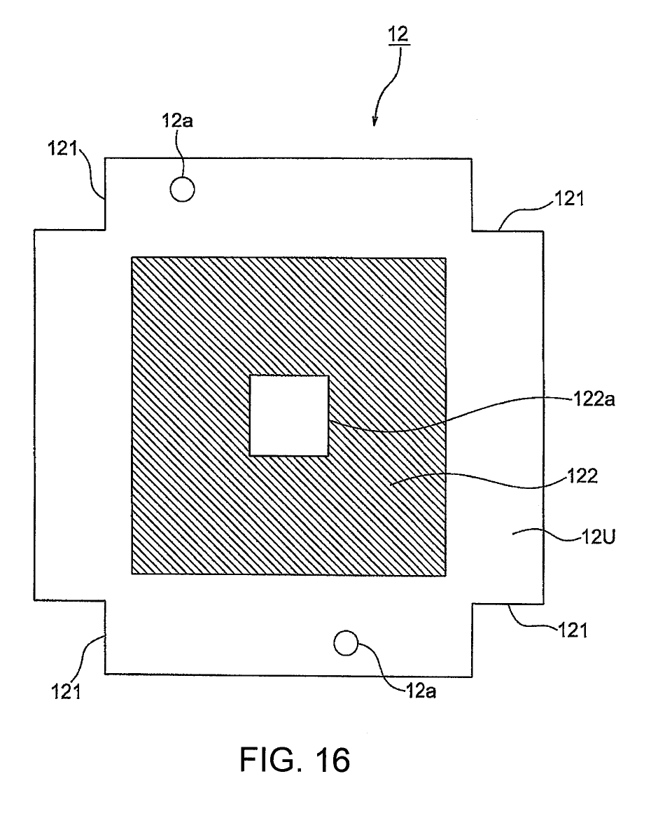

FIG. 16 is a plan view of the antenna board 12. The antenna board 12 has four corners cut in a square shape to allow the bosses 111 of the case 11 to pass therethrough. In other words, the antenna board 12 has notch portions 121 at its four corners. The antenna board 12 also has penetration holes 12a formed at positions corresponding to the two through holes 11b of the case 11 and adapted to insert the positioning pins therethrough. At the center of the upper surface 12U of the antenna substrate 12, the above-mentioned planar antenna element pattern 122 is formed. The planar antenna element pattern 122 is made of, for example, a copper foil. The planar antenna element pattern 122 has a rectangular hole 122a.

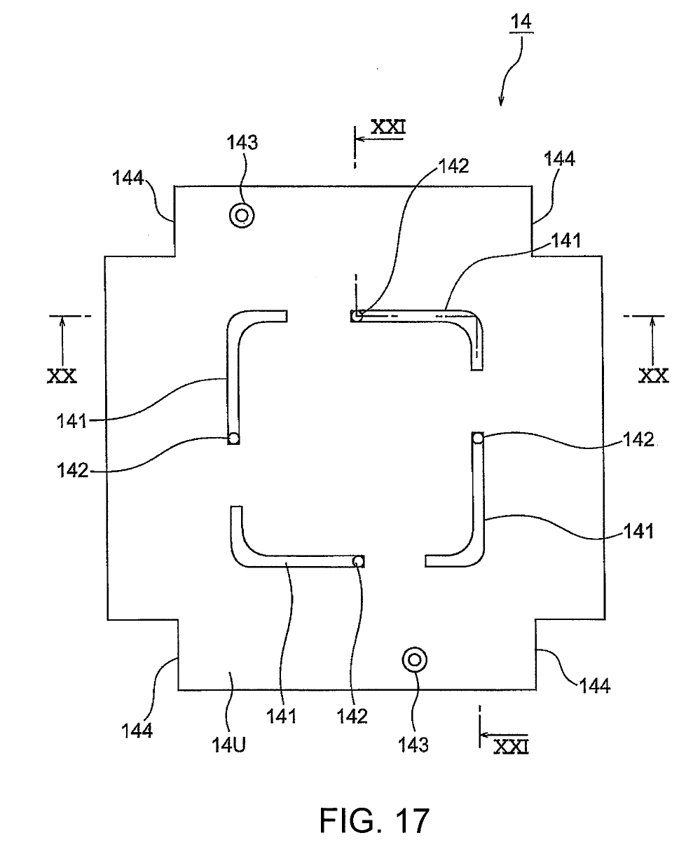

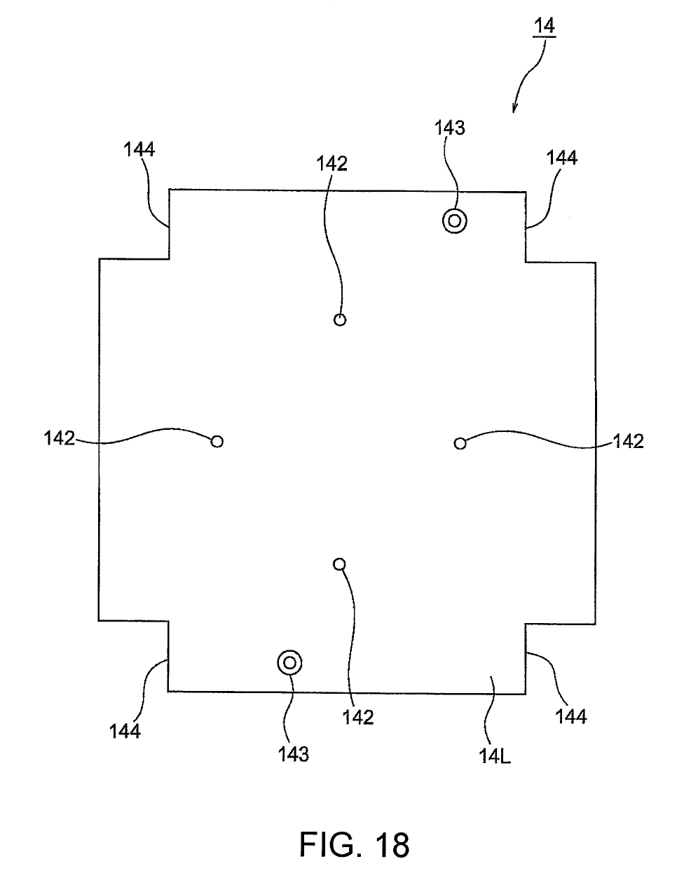

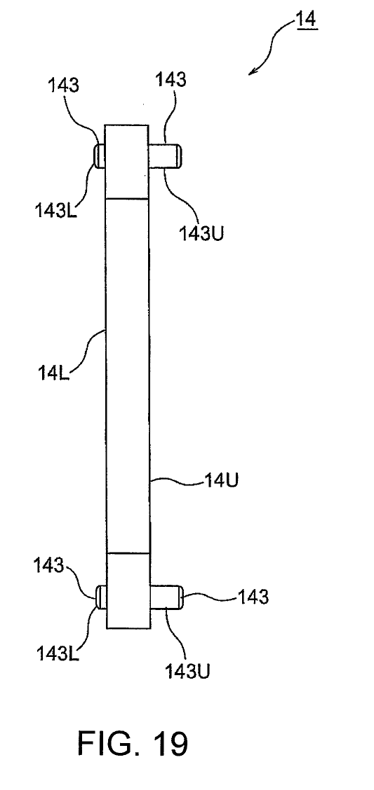

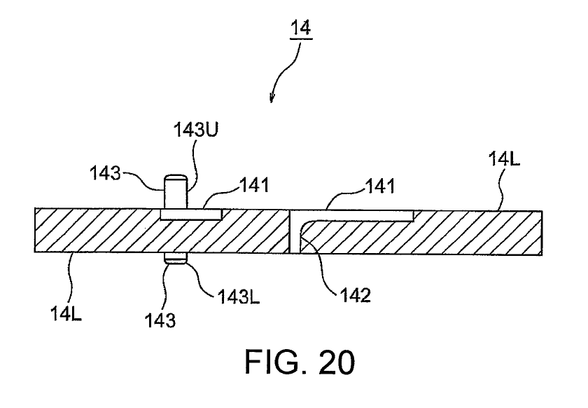

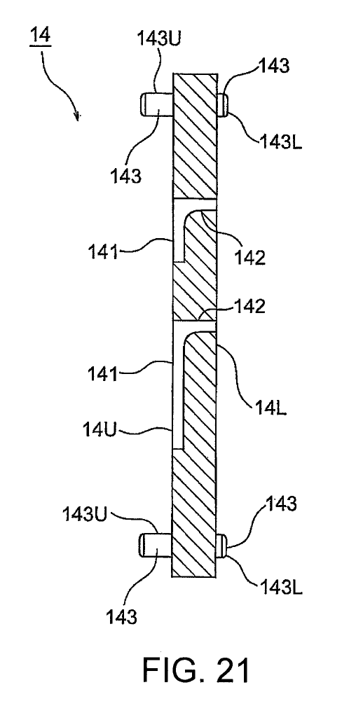

Referring to FIGS. 17 through 21, the description will be made about the base 14. FIG. 17 is a plan view of the base 14. FIG. 18 is a bottom view of the base 14. FIG. 19 is a side view of the base 14. FIG. 20 is a sectional view taken along a line XX-XX in FIG. 17. FIG. 21 is a sectional view taken along a line XXI-XXI in FIG. 17.

The base 14 has the upper surface 14U and a lower surface 14L. The base 14 has the four L-shaped grooves 141 on the upper surface 14U. The base 14 has four penetration holes 142 formed at one ends of the four L-shaped grooves 141 and extending downwards. The first through the fourth probes 131 through 134 mentioned above are disposed along the four L-shaped grooves 141 and the four penetration holes 142, respectively. The base 14 has the above-mentioned two positioning pins 143. The positioning pins 143 extend from the base 14 in a vertical direction. Each of the positioning pins 143 has an upper projecting portion 143U projecting from the upper surface 14U and a lower projecting portion 143L projecting from the lower surface 14L. The upper projecting portion 143U is longer than the lower projecting portion 143L. This is because the upper projecting portion 143U of the positioning pin 143 is required to penetrate the penetration hole 12a of the above-mentioned antenna board 12 and the penetration hole 11b of the above-mentioned case 11. Similarly to the antenna board 12, the base 14 has four corners cut in a square shape to allow the bosses 111 of the case 11 to pass therethrough. In other words, the base 14 has notch portions 144 at its four corners.

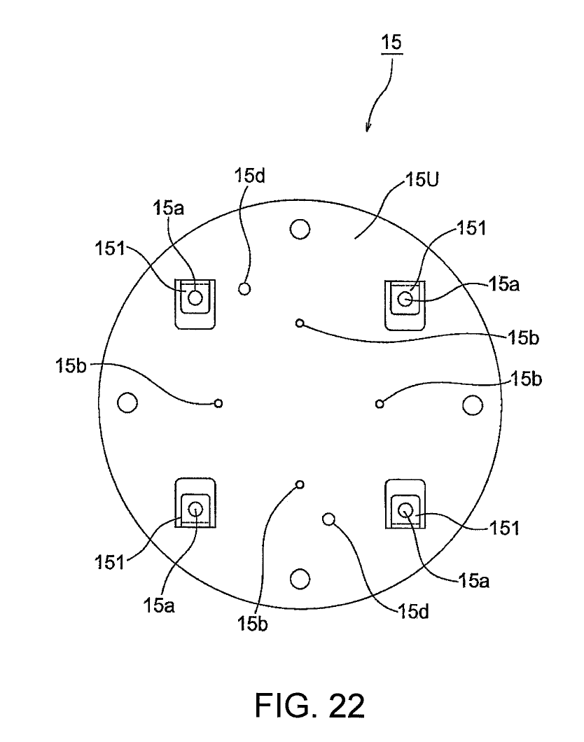

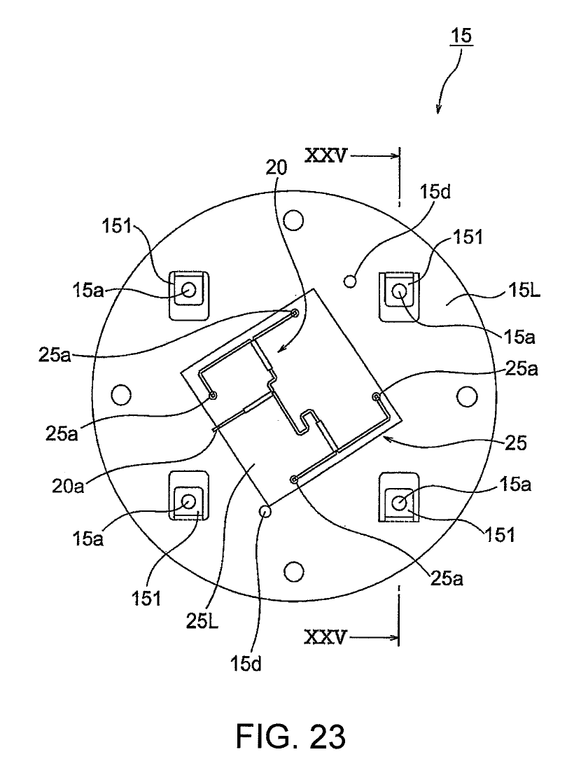

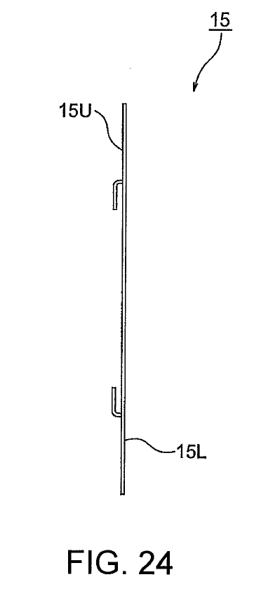

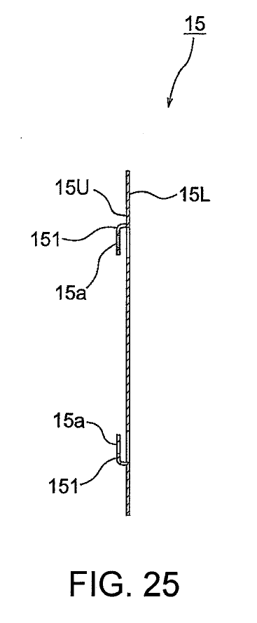

Referring to FIGS. 22 through 25, the description will be made about the ground plate 15 and the circuit board 25. FIG. 22 is a plan view of the ground plate 15. FIG. 23 is a bottom view of the ground plate 15 and the circuit board 25. FIG. 24 is a side view of the ground plate 15. FIG. 25 is a sectional view taken along a line XXV-XXV in FIG. 23.

The ground plate 15 has an upper surface (principal surface) 15U and a lower surface (rear surface) 15L. The ground plate 15 has four screw head receiving portions 151 formed at positions corresponding to the bosses 111 of the case 11 and projecting upwards from the upper surface (principal surface) 15U. Each of the screw head receiving portions 151 is formed by cutting and raising the ground plate 15 and has an L-shaped section. Each of the screw head receiving portions 151 has a height from the lower surface (rear surface) 15L of the ground plate 15, which is greater than a thickness of a head portion 161 of the tapping screw 16. Each of the screw head receiving portion 151 has a penetration hole 15a formed therethrough and allowing a screw portion 162 of the tapping screw 16 to pass therethrough. Each of the screw head receiving portion 151 serves as a washer for the tapping screw 16. Consequently, a washer as a separate component is not necessary. Thus, the number of components can be reduced.

The ground plate 15 has four penetration holes 15b for allowing the first through the fourth feeding probes 131 through 134 to pass therethrough. The ground plate 15 has two penetration holes 15d for inserting the lower projecting portions 143L of the two positioning pins 143 of the base 14, respectively.

As shown in FIG. 23, the circuit board 25 is attached to the lower surface (rear surface) 15L of the ground plate 15. The circuit board 25 has a rear surface 25L with the above-mentioned 90-degree phase shifter 20 formed thereon. Further, the circuit board 25 has four penetration holes 25a for allowing the first through the fourth feeding probes 131 through 134 to pass therethrough.

Referring to FIG. 10, the first through the fourth feeding probes 131 through 134 have first through fourth feeding terminals 131a, 132a, 133a, and 134a formed at their ends penetrating through the four penetration holes 25a of the circuit board 25, respectively. The first through the fourth feeding terminals 131a through 134a are connected to four terminals of the 90-degree phase shifter 20. The 90-degree phase shifter 20 has a feeding point 20a. Incidentally, the 90-degree phase shifter 20 uses, as three coupling portions, Wilkinson couplers which are well known in this technical field.

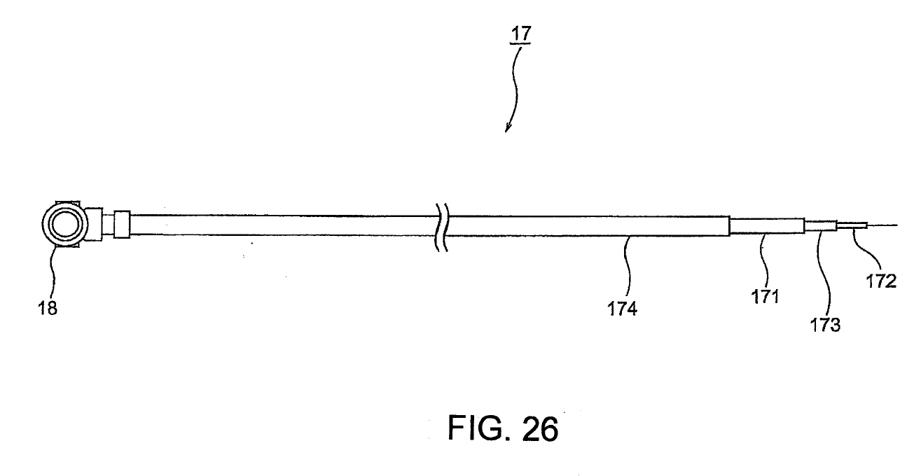

Referring to FIG. 26, the description will be made about a cable 17. The illustrated cable 17 is a coaxial cable. As is well known in the art, the coaxial cable 17 is an electric signal transmission medium having a coaxial configuration comprising a cylindrical outer conductor 171 and a central conductor 172 at the center thereof. The outer conductor 171 and the central conductor 172 are insulated from each other by a cylindrical insulator 173. The external conductor 171 is covered with a sheath 174.

As shown in FIG. 26, at an end portion of the cable 17, the sheath 174, the outer conductor 171, and the insulator 173 of the cable 17 are cut to expose the central conductor 172, the insulator 173, and the outer conductor 171 of the cable 17. On the other hand, the cable 17 has a rear end portion to which a connector 18 is mounted.

As shown in FIGS. 10 and 11, the cable 17 is disposed on the lower surface (rear surface) 15U of the ground plate 15. The central conductor 172 exposed at the end portion of the cable 17 is electrically connected to the feeding point 20a of the 90-degree phase shifter 20 by a solder 21. Further, the outer conductor 173 exposed at the end portion of the cable 17 is electrically connected to the ground plate 15 by a solder 22.

Thus, in the present example, the base 14 is disposed between the ground plate 15 and the antenna board 12 having the planar antenna element pattern 122 formed on the upper surface 12U, and they are fastened by the fastening means. Therefore, with a small number of components, it is possible to maintain a predetermined interval between the planar antenna element pattern 122 and the ground plate 15.

Further, as the fastening means, use is made of the case 11 provided with the four bosses 111 extending downwards and having the screw holes 11a, and the screws 16 screwed to these screw holes. Therefore, four nuts can be omitted to thereby reduce the number of components. Further, the ground plate 15 is provided with the screw head receiving portions 151 projecting upwards therefrom. Therefore, four washers can be omitted to thereby reduce the number of components. Furthermore, the height of the screw head receiving portion 151 from the ground plate 15 is greater than the thickness of the head portion 161 of the screw 16. This provides a structure in which the screws 16 are not projected from the circularly polarized antenna 10. It is therefore possible to eliminate obstacles when the circularly polarized antenna 10 is mounted to and incorporated into a set at a customer's site. Thus, assembling ability can be improved.

Hereinbefore, description has been made about the present invention in connection with the preferred embodiment. However, it will readily be understood that the present invention is not limited to the foregoing embodiment. For example, in the above-mentioned embodiment, only the case where the feeding means comprises the four feeding probes has been described by way of example. However, the number N of the feeding probes may be any number not smaller than two.

1. A circularly polarized antenna comprising:
a planar loop antenna element (122, 122A); and
feeding means (131 through 134; 13A; 13B; and 13C) for providing N-tuple (N being an integer not less than two) feeds with their phases varied by (360/N) degrees with respect to said planar loop antenna element.

2. The circularly polarized antenna as claimed in claim 1, wherein said feeding means comprises first through N-th feeding probes (131 through 134).

3. The circularly polarized antenna as claimed in claim 2, comprising a (360/N)-degree phase shifter (20) connected to said first through said N-th feeding probes.

4. The circularly polarized antenna as claimed in claim 1, wherein said planar loop antenna element has a planar square loop shape (122).

5. The circularly polarized antenna as claimed in claim 1, wherein said planar loop antenna element has a planar circular loop shape (122A).

6. The circularly polarized antenna as claimed in claim 2, wherein each of said first through said N-th feeding probes has an inverted L shape (131 through 134).

7. The circularly polarized antenna as claimed in claim 2, wherein each of said first through said N-th feeding probes has an L shape (13A).

8. The circularly polarized antenna as claimed in claim 2, wherein each of said first through said N-th feeding probes has a T shape (13B).

9. The circularly polarized antenna as claimed in claim 2, wherein each of said first through said N-th feeding probes has an inverted triangular shape (13C).

10. A circularly polarized antenna (10) comprising:
an antenna board (12) having a planar antenna element pattern (122) formed on an upper surface (12U) thereof;
N feeding probes (131 through 134) (N being an integer not less than two) with their phases varied by (360/N) degrees for the purpose of feeding said planar antenna element pattern through electromagnetic coupling;
a ground plate (15) disposed in parallel with said antenna board;
a circuit board (25) disposed on a rear surface (15L) of said ground plate, said circuit board (25) being provided with a (360/N)-degree phase shifter which is formed on a rear surface (25L) thereof and which is connected to said N feeding probes;
a base (14) having N grooves (141) for mounting said N feeding probes and disposed between said ground plate and said antenna board; and
fastening means (11, 16) for fastening said antenna substrate and said ground plate with said base sandwiched therebetween.
